(19) United States
(12) Patent Application Publication
(10) Pub. No.: US 2020/0286198 A1
(43) Pub. Date: Sep. 10, 2020

(54) METHOD AND COMPUTER SYSTEM FOR IMPROVING VEHICLE MANAGEMENT

(71) Applicant: MM Research Inc., Byron Cecnter, MI (US)

(72) Inventor: Manoj Mulki, Byron Center, MI (US)

(73) Assignee: MM Research Inc., Byron Cecnter, MI (US)

(21) Appl. No.: 16/293,380

(22) Filed: Mar. 5, 2019

(51) Int. Cl. G06Q 50/28; G06Q 10/06; G06Q 40/00; G06Q 30/08

(52) U.S. Cl. CPC G06Q 50/28; G06Q 10/063114; H04L 67/10; G06Q 30/08; G06Q 40/125

(57) ABSTRACT

Disclosed is a system for improving vehicle management comprising. In certain embodiments, the system comprises a computerized cloud network, a computing device associated with a driver, a computing device associated with a dispatcher, a computing device associated with a manager, and a computing device associated with a customer. A non-transitory computer-readable medium having computer-executable instructions for performing a method for improving vehicle management encodes instructions to carry out various methods relevant to vehicle management applications.

### BACKGROUND

Reliable fleet management is required by many businesses including the airline industry, courier services, and retail distributors. Digital scanners, wireless networks and cloud storage have revolutionized the way products and goods are delivered. While many such industries have taken full advantage of high-speed communication technologies, others have fallen behind. Construction Supply Companies (CSC) are no exception. The CSC are document-intensive businesses, yet most continue to operate with paper transactions and perform documentation tasks by hand. For example, a CSCs day-to-day responsibilities include transporting raw materials (such as gravel, cement and asphalt) from suppliers to customer sites which require drivers to deal with inspection logs, scale receipts, manifests, and invoices. Dispatchers are often called upon to determine the most efficient routes using maps and coordinating driver schedules using printed forms. CSC managers also deal with extraneous amounts of paperwork when applying for government contracts—such as the those offered through a bidding process by agencies like the department of transportation (DOT). While many CSCs continue to rely on antiquated documentation methods, some in the industry have begun adopting technology to streamline their processes.

Disclosed is a system and method for improving vehicle management. Although this specification focuses on trucking, skilled artisans will appreciate that the system and methods disclosed herein have broad applicability in the transportation and logistics sectors including maritime shipping, railroad transportation, and air shipping. Therefore, the disclosed invention should be interpreted as broadly as reasonably possible.

### BRIEF SUMMARY

Disclosed is a computer system for improving management of vehicles, equipment, and drivers. The system comprises various users who access the system by connecting to a network. The network may be a local network, or it may be accessed through devices coupled to the Internet. Information pertaining to vehicles, equipment, and drivers is transmitted wirelessly to the system through wireless communication devices carried by drivers. The wireless communication devices utilize GPS or other geolocation capabilities to provide an accurate, real-time location of each vehicle. From the information obtained by the driver's wireless communication device, and from data entered by various users including customers, managers, dispatchers, and drivers., the system is able provide data, process data, and execute various functions needed to effectively manage drivers, vehicles, and equipment.

The system also has the ability to expedite other administrative functions such as payroll, legal compliance, and vehicle maintenance. Finally, certain embodiments of the system include functionality through which requests for proposals can be received from customers and bids can be generated in response to such requests.

### FIGURES

FIG. 1 is an illustration of an embodiment of a computer system for improving vehicle management and illustrates user inputs over the system.

FIG. 2 is an illustration of an embodiment of a scheduling platform in an embodiment of a computer system for improving vehicle management.

FIG. 3 is an illustration of an embodiment of a user interface for a system for improving vehicle management.

FIG. 4 is an illustration of an embodiment of a system a method of improving vehicle management wherein document imaging is integrated into the system.

FIG. 5 is an illustration of an embodiment of a computer system for improving vehicle management and various features thereof.

FIG. 6 is an illustration of an embodiment of a computer system for improving vehicle management, having various administrative functions.

FIG. 7 illustrates an embodiment of a user interface in a computer system for alerting users to a new request for a proposal.

FIG. 8 illustrates an embodiment of a user interface displayed on a computer system for generating bids.

### DETAILED DESCRIPTION

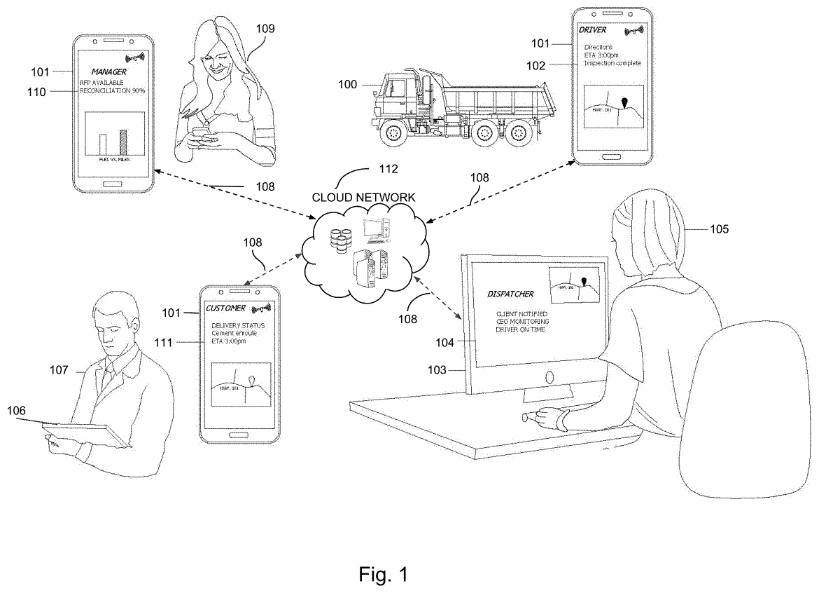

Disclosed is a method and computer system for improving vehicle management. FIG. 1 provides a general overview of an embodiment of such a system and the users. The embodiment illustrated in FIG. 1 includes a manager 109, a driver 100, a customer 107, and a dispatcher 105. These roles are identified only by way of example, and not limitation. Other users may exist on the system and not each specific user is necessary. As illustrated in FIG. 1, the manager 109 is able to view information about a delivery, prospective delivery, or a request for a proposal on a user interface 110 displayed on a smartphone 101. The manager 109 may transmit and receive information 108 to a dispatcher 105. In certain embodiments, managers may log in and log out, recover accounts, view and adjust work orders (modify, cancel and finalize), send work orders to other users (such as drivers, subcontractors, and other managers), and tracking of fleet status and specific trucks. Certain embodiments may include multiple user interfaces, some of which may be displayed on a table or smartphone application. Various embodiments of the user interface may differ based on the device used and the user. The dispatcher 105 may view information a user interface 104 displayed on a desktop computer 103. The dispatcher may then receive and transmit information 108 to a driver 100 or to a customer 107, or back to a manager 109. Each user identified in FIG. 1 may access any information though a smartphone 101, a tablet 106, or a desktop computer 103. In certain embodiments, a driver may use an interface 102 to complete a pre-trip inspection, and to complete any other legal, or regulatory tasks necessary to ensure compliance. The driver may also provide data such as odometer readings, fuel levels, maintenance status, and other data pertaining to the truck or other equipment. Certain embodiments allow a driver use a user interface to log in, recover account credentials, log out, record the beginning and end time of driving or a shift, complete pre and post inspection reports, view and accept work orders, update job status, view and perform navigation functions, view and upload images of documents, view and perform scheduling functions, update profile data, and change passwords and user credentials. Additionally, other computing devices may be used, including laptop computers and any other devices capable of displaying a user interface and communicating with other computer devices. Certain embodiments may allow different access based on device and user. For example, certain embodiments may only allow a drivers and customers to access the system through a user interface on a tablet or smartphone application, allow a manager to access the system through an interface on a tablet or smartphone application or web interface, and allow a dispatcher to access to system through a web-based interface. Any user may use any computing device capable of communicating with the network and capable of carrying out any of methods described herein.

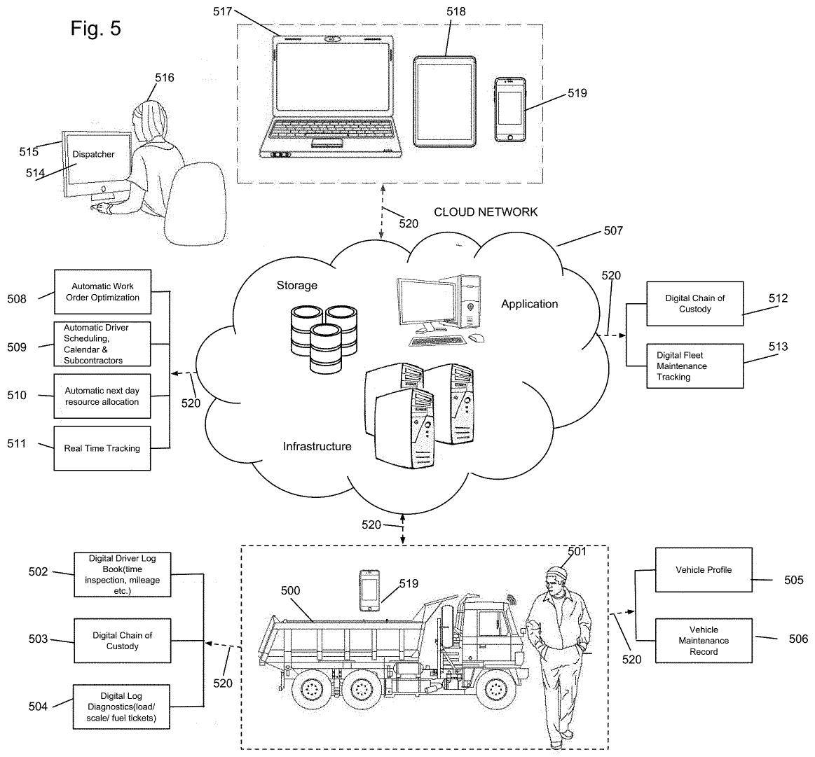

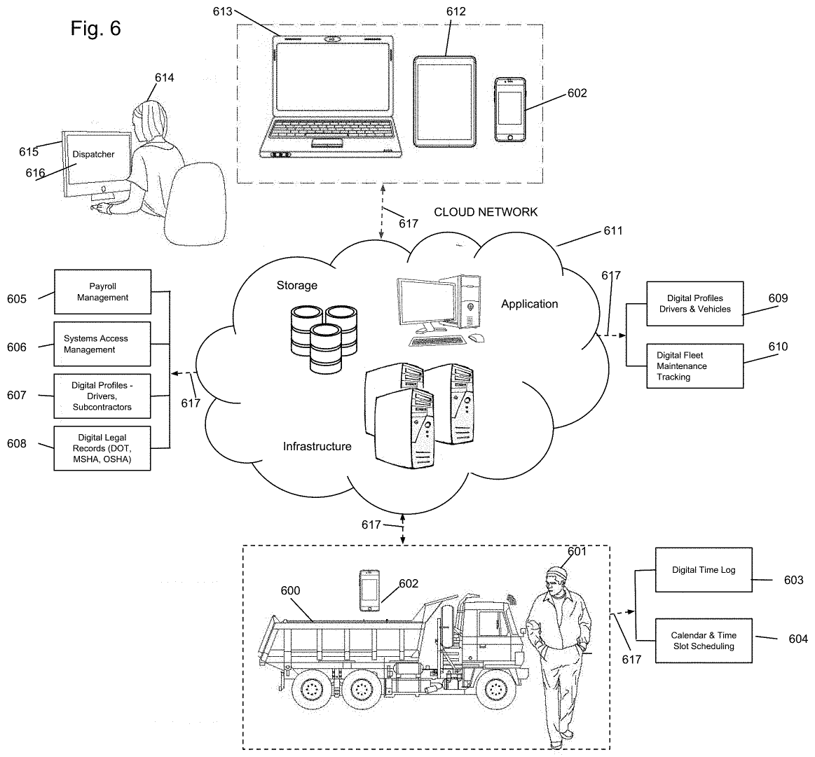

FIG. 5 and FIG. 6 illustrate embodiment of the computer system in greater detail. As illustrated in FIG. 5, users are able to access the system with a desktop computer 515, laptop computer 517, a tablet 518, and a smartphone 519. In certain embodiments, these devices are global positioning system (GPS) enabled and are able to determine the location of the device and transmit this information to the system. Each of these devices is coupled to the Internet or a local network. Certain embodiments of the system comprise a cloud-based network 507. Compute readable instructions encoding the methods disclosed herein reside on computer readable media depicted as storage. The cloud network also comprises servers coupled to the Internet, or one or more networks. These networks may include, but are not limited to, wireless networks, local area networks, and other computer networks over which data may be transmitted. Data transmitted over the network may originate from a dispatcher 516 or a driver 501. Drivers 501 are equipped with a wireless device such as a smart phone 519 but may also be equipped with a tablet, laptop, or other wireless communication device. Data that may be transmitted or stored on the network that may originate from a driver 501 includes a digital driver log 502, digital chain of custody 503 of cargo, digital log of vehicle diagnostics 504. A vehicle profile 505 may also be displayed to a driver, as well as vehicle maintenance records 506. Because the driver's wireless communication device 519 is enabled with GPS or other location tracking capabilities, the system is able to track each vehicle 500. The system associates a wireless communication device with a driver 501 and a vehicle 500 and associations between drivers, vehicles, and wireless communication devises can be altered by users of the system. The tracking functionality enables the system to provide users with real time tracking 511 of vehicles and cargo, enables resource allocation 510 by determining what resources are available, enables automatic scheduling of drivers and subcontracts 509, and provides other work order optimization 508 functions which will provide the optimal routes for operation for that day. These functions are enabled by combining GPS and other tracking technology with input from drivers, dispatchers, and other stakeholders to determine the status and availability of vehicles, drivers, and cargo. The system also stores data, and provides automatic tracking, to create a digital chain of custody 512 and digital fleet maintenance tracking 513. This enables users to have access to real time data as to the location of cargo and the operational and maintenance status of vehicles. Additionally, certain embodiments allow communication between different organizations. For example, one company may wish to subcontract with another company. Certain embodiments will allow data to be exchanged between companies and allow one company to display its availability of resources to other companies. Through this exchange of a data, a company needing resources that it does not presently have, may engage another company that has available resources. Primary contractors may transmit notices to prospective subcontractors through the system, and subcontractors may accept proposals through the system.

FIG. 6 illustrates an embodiment of functions that are enabled by the system that are more administrative in nature. It should be noted that each of functions illustrated in FIG. 6 may combined with one or more of the functions illustrated in FIG. 5. Using the same architecture as illustrated in FIG. 5, the functionality illustrated in FIG. 6 enables users to engage in administrative and legal compliance functions. Drivers 601 of commercial vehicles 600 in many jurisdictions are subject to regulations pertaining to the hours they may legally work. The system compiles data from a driver's 601 wireless communication device 602 to create a digital time log 603. This data may be acquired automatically by sensing when the driver 601 is moving in the vehicle 600 or the data may be inputted manually by the driver 601 through a user interface on the wireless communication device 602. Additionally, a driver may upload digital images of documents or other images that may comprise pertinent records. Data pertaining to Calendar and time also scheduling 604 may be obtained from and displayed to a driver 601. Other functions that may be carried out in certain embodiments of the system include payroll management 605, systems access management 606, creation and management of digital profiles of drivers and subcontractors, 607, and creation and management of digital legal records 608. These functions are performed using a combination of user input and data derived through GPS and other tracking capabilities of the system. For example, the system may infer the hours or distance a driver drove for purposes of payroll. Records may be created based on driver input for legal compliance, thereby determining if a driver is qualified to carry certain cargo. Other records may be created to include expiration of licenses and registrations, medical and drug testing requirements, and other time sensitive data. The system will create alerts to notify users of the need to act on a license or registration that may expire, or the need to have a driver obtain a medical examination or a drug test.

Certain embodiments will comprise unique user interfaces that will vary based on device used and user role. For example, a user interface displayed to a manager will include administrative and management functions not displayed to other users. In such embodiments, a manager will also have the ability to approve or decline a given proposal or bid. Conversely, the user interface displayed to a driver may elicit details pertaining to a vehicle such as mileage, and fuel consumption and may also elicit hours of service and have input fields for human recourse matters. User interfaces may also differ based on the device used. The user interface displayed on a tablet of smartphone may differ from the user interface displayed on a desktop computer, to optimize performance.

The system can determine payroll needs based on hours worked by a given driver. By determining distance traveled, and the time in which the vehicle was in motion, the system can accurately provide payroll functionality. Certain embodiments include a direct interface with payroll processing services or software. Drivers can also use the wireless communication device to advise the system of time off and sick time. This can be transmitted through a user interface, or a message to the system can be transmitted by SMS text message. Once received, the system will update the availability of the driver in the truck, thereby eliminating the need for this step to be performed by a manager or dispatcher.

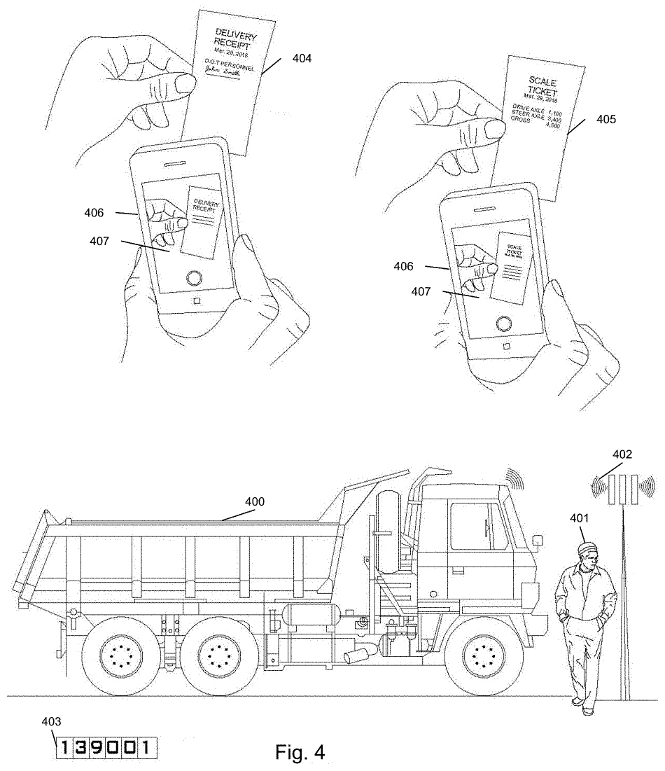

FIG. 4 illustrates certain embodiments that are specific to drivers and vehicles. Drivers may use their wireless communication devices 406, to capture images of documents 404, 405 and upload these documents 404, 405 to the system's storage. Certain embodiments of the system will extract data from the images. This can include confirmations of delivery 404, sales tickets 405, or other documents that may be pertinent. Such imaging can allow the system to quickly process invoices, store proofs of delivery, and perform other administrative functions. Additionally, drivers 401 can use their wireless communication devices to manually enter, or obtain an image of, the odometer reading 403 of their vehicle. In certain embodiments, the system could extract data obtained from digital images, and enter the data to into various reports, and integrates the data into other functions of the system. In alternative embodiments, the system will store the image, and the image may be displayed to a user for entry of the data included in the image. Data transmitted from wireless communication devices 402 is transmitted by radio frequencies to radio receivers 402 which may include traditional radio receivers, repeaters, wireless routers, or cellular data receivers.

If properly equipped, certain embodiments of the system include functionality on a driver's wireless communication device to receive customer payment card information. When customer payment information is captured, the system can transmit information to managers and dispatchers advising that a given invoice has been paid. Customers may receive confirmation through a user interface that payment has been made. In other embodiments, drivers are able to use their wireless communication devices to make purchases of items such as fuel. The system automatically records data of the transaction such as amount of fuel purchased, the vendor from whom fuel was purchased, and the amount paid. Managers and dispatchers are then able to reconcile these transactions, issue settlements to drivers for amounts paid by drivers, and monitor the fuel economy of the vehicles.

The system operates on underlying software that exists as computer executable instructions residing on non-transitory computer readable media. As illustrated in FIG. 5, in certain embodiments, such software resides on a cloud network 507. In alternative embodiments, such software may also reside on local devices. The system is able, through a wireless communication device carried by a driver 501, to determine the location of a vehicle at any given time. The system, combining this location data with other data supplied by another user, can then determine whether a given vehicle will arrive on schedule. In certain embodiments, a dispatcher105, manager 109, or customer 107 may specify a specific time by which a vehicle must arrive at a given location. Based on location data, the system may alert any user to a delay or a timely arrival. This functionality also enables users to determine when a vehicle and driver will be available. From this data, it can also be determined whether a driver has exceeded his or her maximum hours of service. If a vehicle is out of service due to a mechanical issue, the system can display the location of the vehicle, transmit previous maintenance records to any user, including the driver, and receive a notification from a driver that a vehicle is out of service and additional information about the exact nature of the problem encountered.

The system is also integrated to advise customers 107, managers 109, and dispatchers 105, of available cargo to be delivered by a driver and vehicle. As illustrated in FIG. 1, a customer can use a wireless communication device 106,101, through a user interface, to communicate 108 with a dispatcher of an available load of cargo. Because the system is aware of the location of drivers and vehicles, as well as their availability (in terms of work schedule and hours of service), the system can preselect available drivers and vehicles and present these options to a dispatcher 105. This in turn, can be transmitted 108 to a manager for approval, and a driver and vehicle 100 can then be dispatched to a customer through a user interface 104. Certain embodiments of the system will also track inventory. Through a user interface, a user can enter a starting amount of a given supply. As supplies are delivered, the system will keep track and display this data, through the user interface, to users. The system will also alert users when a given supply is low in quantity and an additional delivery is needed. The system will also alert users when there is an excess of a given supply and avoid an oversupply of inventory. If after a given delivery, the amount of a given supply at a given location is below a preestablished level, the system can automatically schedule delivery of the supply for replenishment. Conversely, if the system detects that there is an excess quantity of a given supply at a given location, the system can direct an available driver and vehicle to transport the excess amount to a different location.

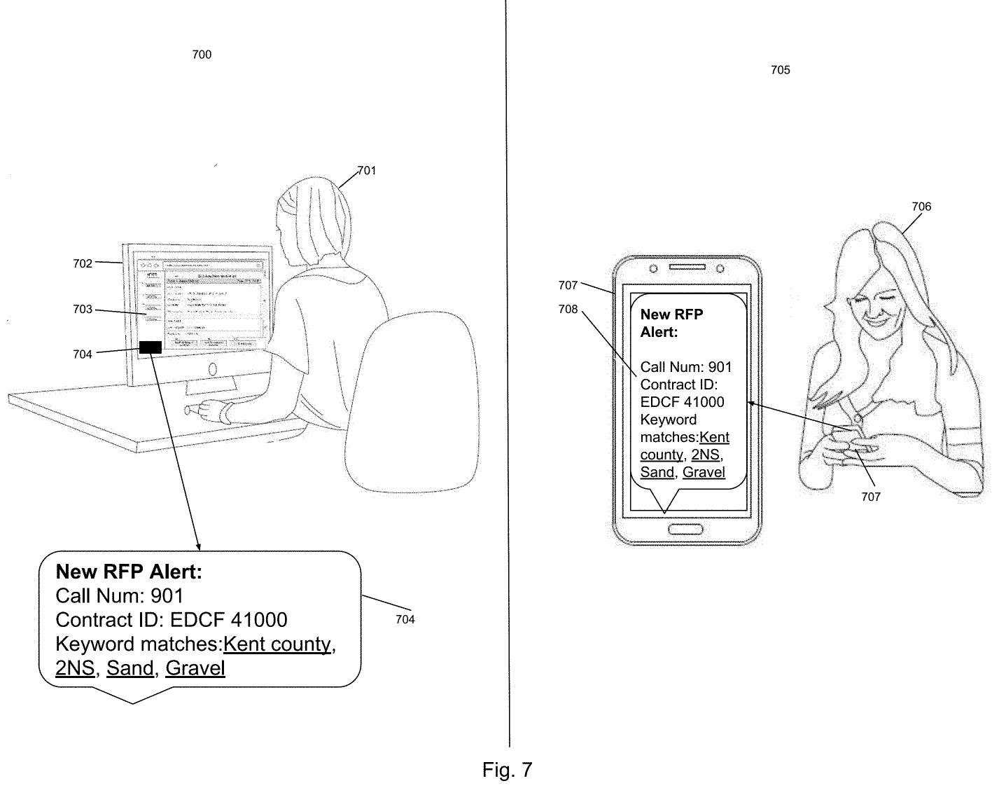

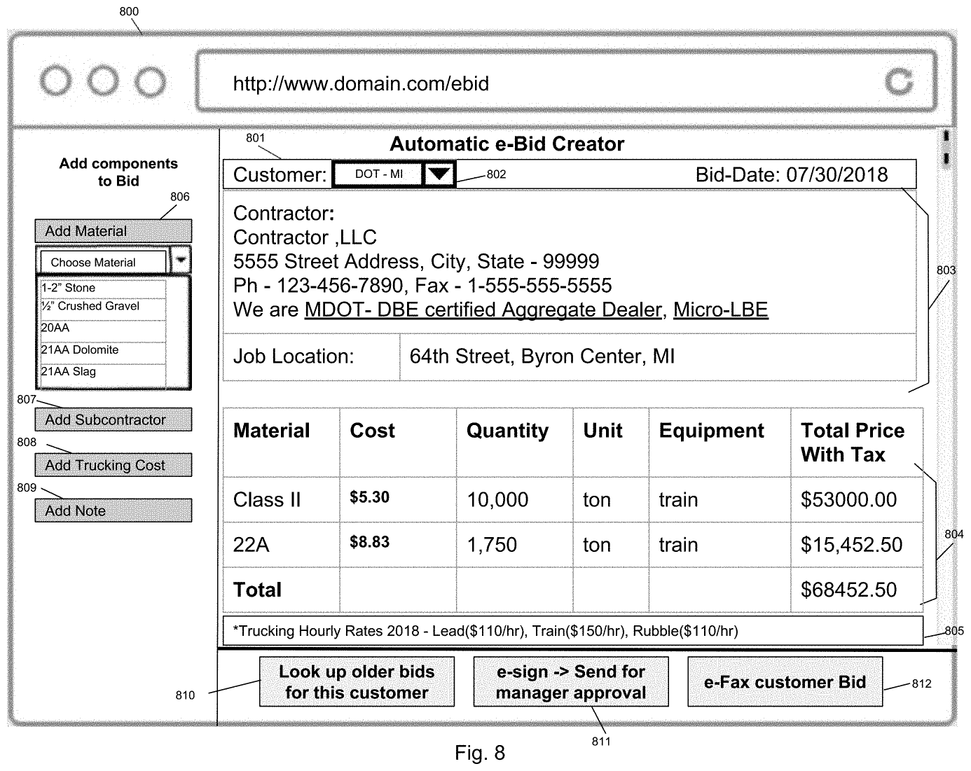

FIG. 7 illustrates an embodiment of a user interface wherein a user receives an alert for a new request for a proposal. A customer may transmit a request for proposal through the system. A user 701 may receive the alert 704 through a user interface 703 on a desktop computer 702. Alternatively, a user 706 may also receive an alert through a user interface 708 on a smart phone 707. In response to a request for proposal, a user may respond and create a bid through the system. FIG. 8 illustrates an embodiment of a user interface 800 that displays an automatic bid creator. The bid allows a user to select a customer 801 through a dropdown menu 802, from the list of customers that is stored in the system. Information about the Contractor is displayed. A list of materials and material costs is also displayed 804. The user may select materials 806, add subcontractors 807, add trucking costs 808, and notes 809 through dropdown menus. Notes 805 are also displayed on the user interface. A user also has options to look up older bids for a specified customer 810, sign and send the bid for manager approval 811, or transmit the bid to a customer 812. If a user elects to send a bid for manager approval, the system will transmit the bid to a manager. A manager may then approve or reject the bid through a user interface desktop computer or other device. Alternatively, a manager may accept or reject a given bid through an email message, or a text message. Similarly, the system will also transmit a bid to a customer if a user selects this option. A manager may suggest changes to a given bid. In this instance, a customer may then accept or reject the bid through a user interface displayed in a computer or other device.

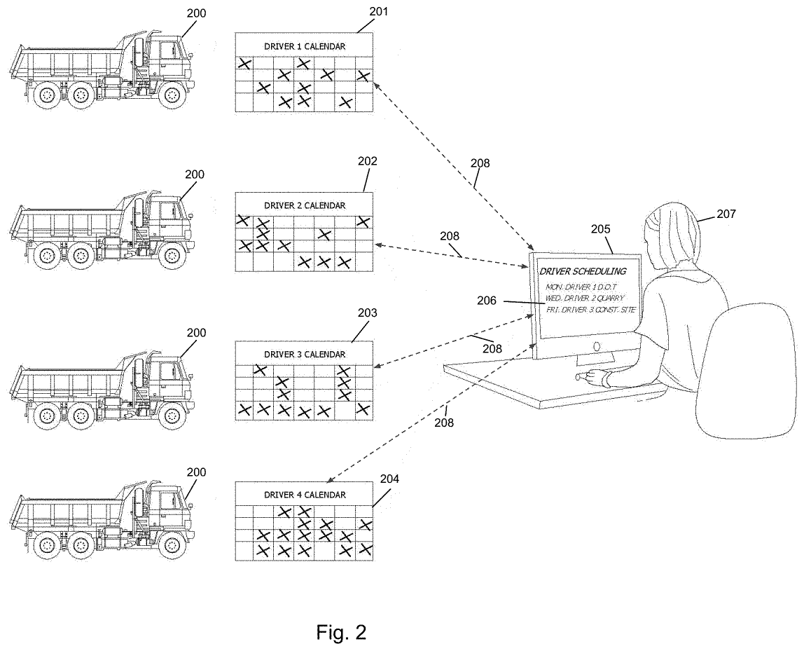

FIG. 2 illustrates an embodiment of a method carried out by the system to display driver and vehicle availability to a dispatcher 207. The system will display a given driver's availability. In the illustration provided, four representative driver schedules are shown: driver 1 201, driver 2 202, driver 3 203, and driver 4 204. These schedules may be determined by user inputs (driver specifying specific days or availability, a dispatcher or manager selecting drivers to work certain jobs or days) and can also be determined based on the system's determination of a given driver's hours of service or the jobs that are currently available. From the information provided by the system, a dispatcher 207 can reliably determine which drivers are available. Settings can be created by managers or dispatchers, through a user interface, to determine when a driver may be available to work or when the driver may not be available for work. For example, settings can be established that will limit the total number of hours a driver may work. If a given job assignment would require hours in excess of the driver's available hours, the system would indicate that the driver is not available for that work assignment. Conversely, the system would show, and may assign jobs to drivers, who have sufficient available hours to complete a given task. Additionally, user may enter data into the system relating to regulatory compliance. License and certification information can be entered onto the profiles of drivers and vehicles. The system will use this information to ensure that only drivers and vehicles in regulatory compliance with pertinent laws and regulations are assigned to tasks wherein such compliance is necessary.

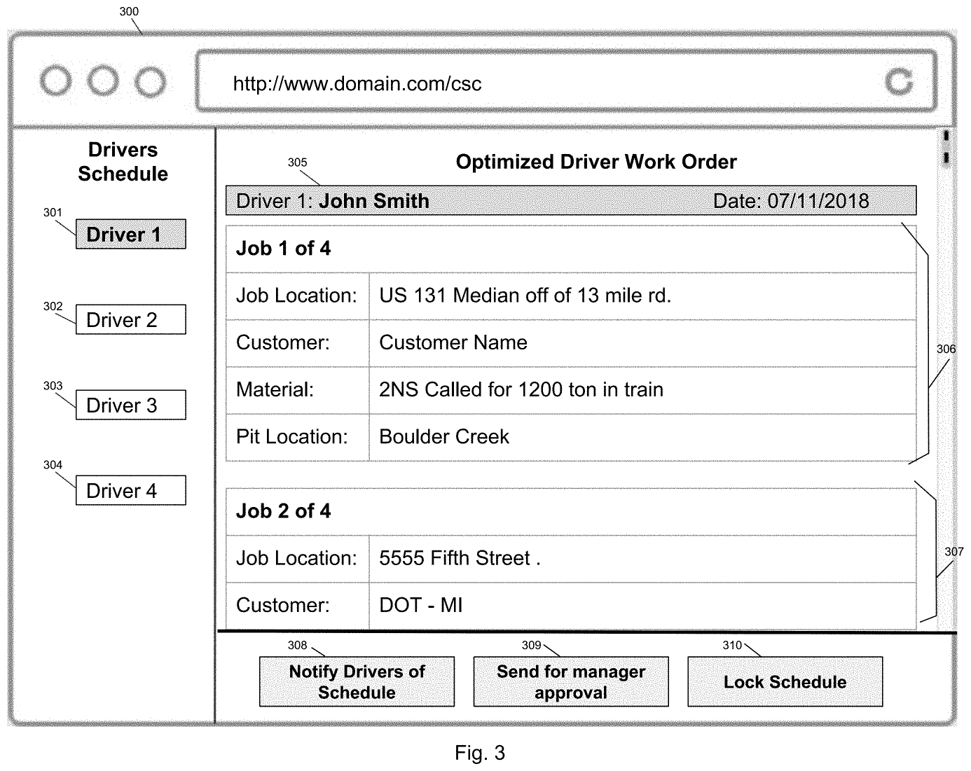

FIG. 3 illustrates an embodiment of a user interface 300 on a desktop computer used to create a work order. Certain alternative embodiments comprise a similar user interface on a different deice such a smartphone or tablet. The data displayed on the user interface 300 is obtained through the methods previously disclosed. The user interface 300 illustrated in FIG. 3 is a work order. The user interface 300 displays, to a user, likely a dispatcher, an optimized work order. The optimization of the work order is determined by data obtained by the system and is determined to be the most economical means of completed the requested work. The system determines the optimized work order based on factors including expected driver schedules, driver availability, weather, truck routes, proximity of other deliveries and worksites, traffic, and availability of supplies and equipment. Driver 1 301, driver 2 302, driver 3 303, and driver 4 304 are shown as a representative list of drivers. The user interface displays details about a requested first job 306 and about a requested second job 307. Once a driver 305 is selected, a user may notify the drivers of the schedule that will be generated 308, send for manager approval 309, or lock the schedule 310 in the system. Notifications may be sent to drivers through the system, and drivers are then notified through a user interface 102 on a wireless communication device 101. Information and status updates may also be transmitted to customers. All such information may also be viewed through a user interface by other users of the system.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A system for improving vehicle management comprising:
a computerized cloud network;
a computing device associated with a driver, wherein the computing device associated with the driver is coupled to the cloud network;
a computing device associated with a dispatcher, wherein the computing device associated with the dispatcher is coupled to the cloud network;
a computing device associated with a manager, wherein the computing device associated with the manager is coupled to the cloud network;
a computing device associated with a customer, wherein the computing device associated with customer is coupled to the cloud network; and
a non-transitory computer-readable medium having computer-executable instructions for performing a method for improving vehicle management comprising receiving location data from the computing device associated with the driver.

2. The system for improving vehicle management of claim 1 wherein the computing device associated with the driver further comprises a global positioning system.

3. The system for improving vehicle management of claim 2 wherein the computing device associated with the driver is also associated with a vehicle.

4. The system for improving vehicle management of claim 3 wherein the non-transitory computer-readable medium having computer-executable instructions for performing a method for improving vehicle management further comprises:
receiving data from the computing device associated with the driver relating to time driven by a driver; and
receiving data from the computing device associated with the driver relating to distance driven.

5. The system for improving vehicle management of claim 4 wherein the non-transitory computer-readable medium having computer-executable instructions for performing a method for improving vehicle management further comprises:
receiving a work order from the computing device associated with the customer, through a user interface;
determining the driver is able to perform the requested work;
transmitting a work order to the computing device associated with the driver; and
transmitting a status of the work order to the computing device associated with the customer, through a user interface.

6. The system for improving vehicle management of claim 5 wherein the computing device associated with the driver is capable of capturing and transmitting digital images.

7. The system for improving vehicle management of claim 6 wherein the non-transitory computer-readable medium having computer-executable instructions for performing a method for improving vehicle management further comprises:
receiving digital images from the computing device associated with the driver; and
extracting data from the digital images received from the computing device associated with the driver.

8. A system for improving vehicle management comprising:
a computerized cloud network;
a computing device associated with a driver, wherein the computing device associated with the driver is coupled to the cloud network;
a computing device associated with a dispatcher, wherein the computing device associated with the dispatcher is coupled to the cloud network;
a computing device associated with a manager, wherein the computing device associated with the manager is coupled to the cloud network;
a computing device associated with a customer, wherein the computing device associated with customer is coupled to the cloud network; and
a non-transitory computer-readable medium having computer-executable instructions for performing a method for improving vehicle management comprising receiving a request for proposal from the computing device associated with the customer.

9. The system for improving vehicle management of claim 8 wherein the non-transitory computer-readable medium having computer-executable instructions for performing a method for improving vehicle management further comprises delivering an alert, on the computing device associated with the manager or the computing device associated with the dispatcher, that a request for a proposal has been received.

10. The system for improving vehicle management of claim 9 wherein the non-transitory computer-readable medium having computer-executable instructions for performing a method for improving vehicle management further comprising:
creating a bid, in response to a request for proposal, through a user interface; and
transmitting the bid to a computing device associated with a customer.

11. The system for improving vehicle management of claim 10 wherein the bid created though the user interface comprises:
a customer name;
a material;
a note; and
a cost;
wherein the customer name, the material, the note, and the cost are added or selected though the user interface.

12. The system for improving vehicle management of claim 12 wherein the non-transitory computer-readable medium having computer-executable instructions for performing a method for improving vehicle management further comprising:
selecting the driver for a work order;
transmitting the work order to the computing device associated with the driver; and
displaying the work order to the driver.

13. The system for improving vehicle management of claim 12 wherein the computing device associated with the driver further comprises a global positioning system.

14. The system for improving vehicle management of claim 14 wherein the non-transitory computer-readable medium having computer-executable instructions for performing a method for improving vehicle management further comprising transmitting a status of the work order to the computing device associated with the customer.

15. The system for improving vehicle management of claim 14 wherein the non-transitory computer-readable medium having computer-executable instructions for performing a method for improving vehicle management further comprising:
receiving data from the computing device associated with the driver relating to time driven by a driver; and
receiving data from the computing device associated with the driver relating to distance driven.

16. The system for improving vehicle management of claim 15 wherein the non-transitory computer-readable medium having computer-executable instructions for performing a method for improving vehicle management further comprises:
receiving digital images from the computing device associated with the driver; and
extracting data from the digital images received from the computing device associated with the driver.

17. The system for improving vehicle management of claim 16 wherein the non-transitory computer-readable medium having computer-executable instructions for performing a method for improving vehicle management further comprises:
obtaining payment from the customer through the computing device associated with the driver;
transmitting payment information to the system; and
transmitting a confirmation of payment to the computing device associated with the customer.

18. The system for improving vehicle management of claim 17 wherein the non-transitory computer-readable medium having computer-executable instructions for performing a method for improving vehicle management further comprises:
receiving mileage information from the computing device associated with the driver; and
receiving fuel information from the computing device associated with the driver.

19. The system for improving vehicle management of claim 18 wherein the non-transitory computer-readable medium having computer-executable instructions for performing a method for improving vehicle management further comprises:
calculating hours or distance driven by the driver; and
providing the hours or distance driven by the driver to a payroll service.

20. system for improving vehicle management of claim 20 wherein the non-transitory computer-readable medium having computer-executable instructions for performing a method for improving vehicle management further comprises displaying the availability of the driver to the dispatcher through the computing device associated with the dispatcher.
